(19) United States
(12) Patent Application Publication
(10) Pub. No.: US 2026/0254260 A1
(43) Pub. Date: Aug. 27, 2026

(54) Transistor Charge Control For Multi-Cell Batteries

(71) Applicant: Schumacher Electric Corporation, Fort Worth, TX (US)

(72) Inventors: Barry O’Dell, Fort Worth, TX (US); Het Patel, Irving, TX (US)

(21) Appl. No.: 19/544,507

(22) Filed: Feb. 19, 2026

Related U.S. Application Data
(60) Provisional application No. 63/763,550, filed on Feb. 26, 2025.

(51) Int. Cl. H02J 7/34; B60R 16/033; H02J 7/00; H02J 7/42; H02J 7/44; H02J 7/62; H02J 7/64; H02J 7/65; H02J 7/68; H02J 7/70; H02J 7/90; H02J 7/96

(52) U.S. Cl. CPC H02J 7/342; B60R 16/033; H02J 7/42; H02J 7/44; H02J 7/62; H02J 7/64; H02J 7/65; H02J 7/68; H02J 7/731; H02J 7/875; H02J 7/933; H02J 7/96; H02J 7/977; H02J 2207/20; H02J 2207/30

(57) ABSTRACT

A portable jump-starting device includes an internal multi-cell lithium battery pack, a power conversion circuit, and a battery charge and discharge control circuit. The control circuit includes a battery management integrated circuit that monitors cell voltages, current, and temperature, and independently controls transistors arranged in separate charge and discharge current paths. A charge transistor and diode selectively couple a regulated charging source to the battery pack, and a discharge transistor and diode selectively couple the battery pack to external terminal connectors. The battery management integrated circuit disables charging or discharging in response to over-voltage, under-voltage, over-current, or over-temperature conditions. In certain embodiments, a relay is connected in parallel with a discharge diode to provide a low-resistance path during high-current jump-starting operations.

### RELATED APPLICATIONS

The present application claims the benefit under 35 U.S.C. §119(e) of U.S. Provisional Patent Application No. 63/763,550, filed February 26, 2025, and titled “Transistor Charge Control For Multi-Cell Batteries,” the contents of which are hereby incorporated by reference.

### BACKGROUND

It is well known that motorists from time to time find themselves with a battery of insufficient charge to start their vehicle. This is generally an occasion of extreme inconvenience and distress, particularly where one finds himself in this situation in an area where there are other vehicles and drivers, but no means for connecting the battery of the disabled vehicle to the battery of one of the other available vehicles. Despite the advancements thus far, a need exists for an improved battery booster, and, more particularly, to improved charging circuitry for an internal lithium battery of a battery booster.

### SUMMARY

The present disclosure relates generally to a charge circuit, substantially as illustrated by and described in connection with at least one of the figures, as set forth more completely in the claims. In one example, the present disclosure relates generally to a charge circuit for charging an internal battery (e.g., a multicell lithium battery or other battery pack) in an automotive booster/jump starter.

### BRIEF DESCRIPTION OF THE DRAWINGS

The foregoing and other objects, features, and advantages of the devices, systems, and methods described herein will be apparent from the following description of examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a front perspective view of an exemplary battery booster.

FIG. 1b illustrates a block diagram of an example battery booster.

FIG. 1c illustrates a schematic diagram of an example battery booster.

FIG. 1d illustrates a communication network for use with the battery booster.

FIG. 2 illustrates an electrical schematic of an overcharge and over-discharge protection subcircuit (Detail A) in accordance with an aspect of the present disclosure.

FIG. 3 illustrates an electrical schematic of an overcharge protection subcircuit (Detail B) in accordance with another aspect of the present disclosure.

FIG. 4 illustrates an electrical schematic of an overcharge and over-discharge protection subcircuit (Detail C) in accordance with yet another aspect of the present disclosure.

FIG. 5 illustrates an electrical schematic of an overcharge and over-discharge protection subcircuit (Detail D) in accordance with yet another aspect of the present disclosure.

### DETAILED DESCRIPTION

Preferred examples of the present disclosure will be described hereinbelow with reference to the accompanying drawings. In the following description, well-known functions or constructions are not described in detail because they may obscure the disclosure in unnecessary detail. The present disclosure relates to a battery booster system, method, and apparatus. For this disclosure, the following terms and definitions shall apply:

As used herein, the word “exemplary” means “serving as an example, instance, or illustration.” The examples described herein are not limiting, but rather are exemplary only. It should be understood that the described examples are not necessarily to be construed as preferred or advantageous over other examples. Moreover, the terms “examples of the invention,” “examples,” or “invention” do not require that all examples of the invention include the discussed feature, advantage, or mode of operation.

The terms “communicate” and “communicating” as used herein, include both conveying data from a source to a destination and delivering data to a communications medium, system, channel, network, device, wire, cable, fiber, circuit, and/or link to be conveyed to a destination. The term “communication” as used herein means data so conveyed or delivered. The term “communications” as used herein includes one or more of a communications medium, system, channel, network, device, wire, cable, fiber, circuit, and/or link.

The terms “coupled,” “coupled to,” and “coupled with” as used herein, each mean a relationship between or among two or more devices, apparatuses, files, circuits, elements, functions, operations, processes, programs, media, components, networks, systems, subsystems, and/or means, constituting any one or more of: (i) a connection, whether direct or through one or more other devices, apparatuses, files, circuits, elements, functions, operations, processes, programs, media, components, networks, systems, subsystems, or means; (ii) a communications relationship, whether direct or through one or more other devices, apparatuses, files, circuits, elements, functions, operations, processes, programs, media, components, networks, systems, subsystems, or means; and/or (iii) a functional relationship in which the operation of any one or more devices, apparatuses, files, circuits, elements, functions, operations, processes, programs, media, components, networks, systems, subsystems, or means depends, in whole or in part, on the operation of any one or more others thereof.

The term “data” as used herein means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” is used to represent predetermined information in one physical form, encompassing any and all representations of corresponding information in a different physical form or forms.

The term “database” as used herein means an organized body of related data, regardless of the manner in which the data or the organized body thereof is represented. For example, the organized body of related data may be in the form of one or more of a table, map, grid, packet, datagram, frame, file, email, message, document, report, list, or any other form.

The term “network” as used herein includes both networks and inter-networks of all kinds, including the Internet, and is not limited to any particular network or inter-network.

The term “processor” as used herein means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

In one aspect, a portable jump-starting device for supplying power to a vehicle having an external battery comprises a pair of terminal connectors configured to be electrically coupled to the external battery, an internal power source comprising a multi-cell lithium battery pack, a power conversion circuit configured to provide a regulated charging voltage, and a battery charge and discharge control circuit coupled between the internal power source and at least one of the terminal connectors and the power conversion circuit. The battery charge and discharge control circuit comprises a battery management integrated circuit configured to monitor voltage, current, and temperature conditions of the multi-cell lithium battery pack, a charge current path including a first transistor and a first diode arranged in series between the power conversion circuit and the multi-cell lithium battery pack, and a discharge current path including a second transistor and a second diode arranged in series between the multi-cell lithium battery pack and the terminal connectors. The battery management integrated circuit is configured to independently control the control terminals of the first and second transistors to selectively enable and disable charging and discharging of the multi-cell lithium battery pack.

In certain examples, the battery management integrated circuit is configured to monitor individual cell voltages of the multi-cell lithium battery pack through a plurality of cell sensing inputs. The battery management integrated circuit may include a charge control output and a discharge control output, the charge control output being coupled to a gate control network associated with the first transistor and the discharge control output being coupled to a gate control network associated with the second transistor. The battery charge and discharge control circuit may further comprise a third transistor configured to selectively control a control terminal of the first transistor in response to a charge control signal from the battery management integrated circuit, and/or a fourth transistor configured to selectively control a control terminal of the second transistor in response to a discharge control signal from the battery management integrated circuit. In some implementations, the third transistor is configured to pull the control terminal of the first transistor toward a reference potential to disable charging.

The first diode may be configured to prevent reverse current flow from the multi-cell lithium battery pack toward the power conversion circuit, and the second diode may be configured to prevent reverse current flow from the terminal connectors toward the multi-cell lithium battery pack. The battery management integrated circuit may be configured to disable at least one of the first and second transistors in response to detection of an over-voltage condition of at least one lithium battery cell, an under-voltage condition of the multi-cell lithium battery pack, an over-current condition during a jump-starting operation, or a temperature condition exceeding a predetermined threshold.

In some examples, the power conversion circuit comprises a single-ended primary-inductor converter (SEPIC) configured to provide the regulated charging voltage to the multi-cell lithium battery pack through the charge current path. The battery charge and discharge control circuit may further comprise a resistor network coupled to the control terminals of the first and second transistors and configured to provide biasing, pull-up, pull-down, and signal conditioning functions. Charging and discharging of the multi-cell lithium battery pack may be independently controlled through separate current paths.

In certain examples, the first transistor is positioned directly in series between an output of the power conversion circuit and the multi-cell lithium battery pack, and a control terminal of the first transistor is biased through a resistor to a conductive state when an associated gate control transistor is non-conductive. In other examples, the battery charge and discharge control circuit further comprises a relay connected in parallel with the second diode in the discharge current path, the relay being configured to provide a low-resistance discharge path during a high-current jump-starting operation and being controlled by a transistor driven by the battery management integrated circuit. When charging and discharging are disabled, the battery charge and discharge control circuit electrically isolates the multi-cell lithium battery pack from both the power conversion circuit and the terminal connectors.

A battery booster, as disclosed herein, may be used to start (also referred to as “boost,” “jump,” or “jump-start”) an engine operatively coupled to an external battery 104, such as a 6-, 12-, 24-, or 48- nominal-voltage vehicular battery or battery bank that may be fully or partially depleted. In certain aspects, the battery booster 100 may additionally be configured to charge the external battery 104 and/or other electronic devices operatively coupled with the battery booster 100. Example external batteries include, without limitation, lead-acid batteries (e.g., wet or flooded batteries, calcium-calcium batteries, valve-regulated lead-acid (VRLA) batteries, gel cells, and absorbed glass mat (AGM) batteries) and other rechargeable batteries, such as lithium-ion, lithium-ion polymer, nickel-metal hydride (NiMH), and nickel-cadmium (NiCd) batteries. Other electronic devices that may be operatively coupled with the battery booster 100 include, for example, portable electronic devices 152 (e.g., phones, tablet computers, portable computers), toys, and similar devices.

The present disclosure relates to a battery booster system, method, and apparatus, including a charge circuit for charging the battery of an automotive booster/jump starter. A suitable example automotive booster/jump starter that could employ the various circuits disclosed herein includes those disclosed by commonly owned U.S. Patent No. 11,973,366 to Patrick J. Clarke, which issued on April 30, 2024, and is titled “Battery Booster,” and commonly owned U.S. Patent No. 11,674,490 to Patrick J. Clarke, which issued on June 13, 2023, and is titled “Multifunctional Battery Booster.” Each of the foregoing patents is hereby incorporated by reference in its entirety.

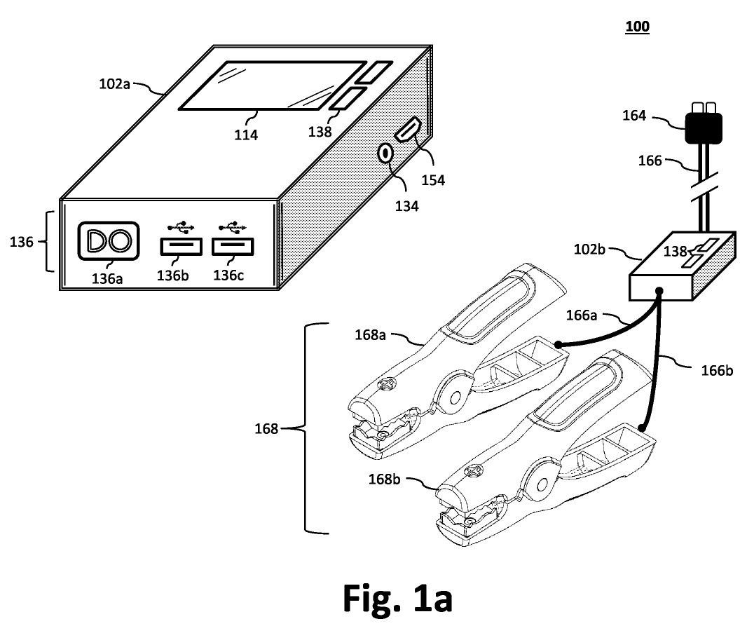

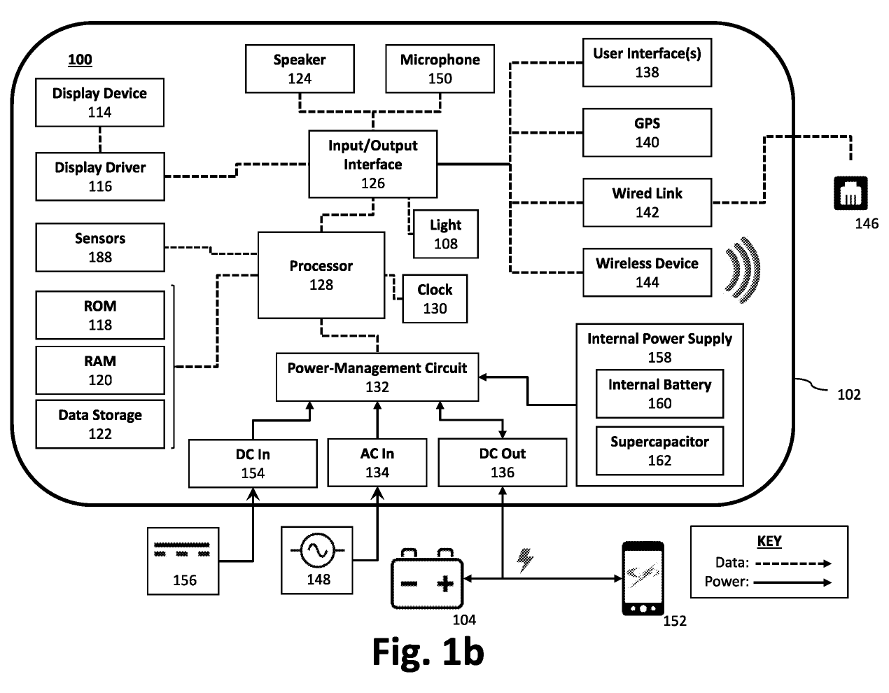

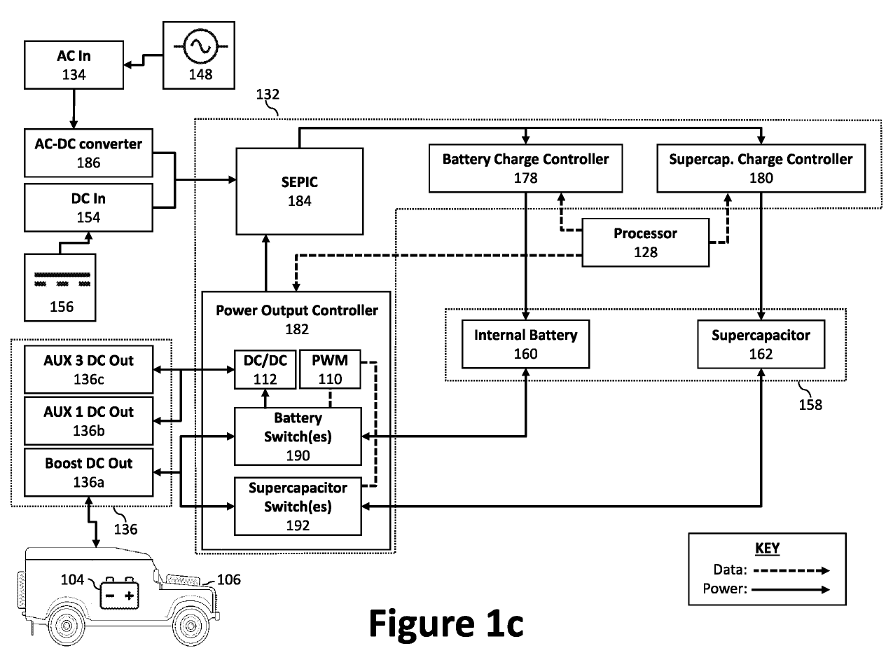

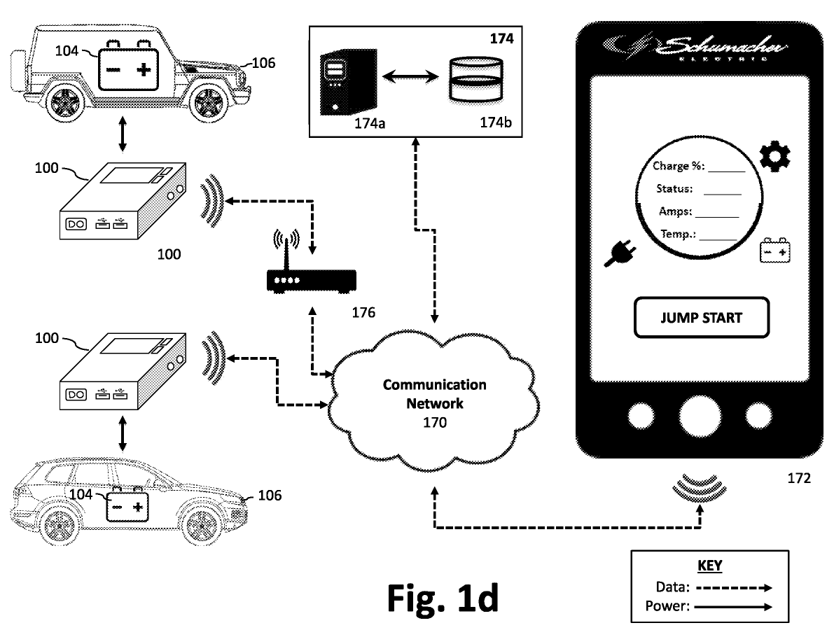

FIG. 1a illustrates a front perspective view of an exemplary battery booster 100. The battery booster 100 may be compact, lightweight, and capable of handheld use. As illustrated, the battery booster 100 may comprise one or more housings 102, such as a first housing 102a and a second housing 102b. The one or more housings 102 may include, inter alia, a display device 114, an AC input terminal 134, a user interface 138, a plurality of DC output terminals 136, and/or a DC input terminal 154. The plurality of DC output terminals 136 may be used to charge external batteries 104 or portable electronic devices 152, to boost a vehicle 106 or external battery 104, or otherwise to supply power to external devices. By way of example, the DC output terminals 136 may include a DC booster output 136a, a first DC accessory output 136b, and a second DC accessory output 136c.

In certain aspects, one or both of the first DC accessory output 136b and the second DC accessory output 136c may comprise a USB port, a 12-volt port (e.g., a cigarette lighter socket), or a similar interface. In some examples, a DC connector may function as both the DC input terminal 154 and one of the DC output terminals 136.

While the components of the battery booster 100 may be provided within a single housing 102, it may be advantageous in certain aspects to locate selected components in the second housing 102b, thereby reducing the size of the first housing 102a. For example, components primarily associated with jump-starting an engine may be provided in the second housing 102b, while components associated with accessory charging functions may be provided in the first housing 102a.

The battery booster 100 may be removably coupled with a vehicle 106 or an external battery 104 via a pair of electrical conductors 166, such as positive and negative electrical conductors 166a and 166b, which may be electrically coupled with the battery booster 100 at one of the DC output terminals 136, such as the DC booster output 136a. Each electrical conductor 166 may comprise a battery cable having a terminal connector at its distal end. The terminal connectors may include, for example, battery clamps 168 (i.e., a positive clamp 168a and a negative clamp 168b), ring terminals, quick-connect plugs, or similar connectors. As illustrated, the second housing 102b and associated circuitry may be positioned in-line along one or both of the electrical conductors 166 between the battery booster 100 and the terminal connectors. For example, a processor 128 and at least a portion of a power management circuit 132 may be housed within the second housing 102b. In certain aspects, detachable electrical ports or connectors 164 may be integral with, or coupled directly to, the second housing 102b.

In addition to conveying charging current and/or boosting current to the external battery 104, the battery booster 100 may be configured to measure battery voltage and/or current via the electrical conductors 166a and 166b. In certain aspects, the electrical conductors 166a and 166b may employ battery clamps 168 capable of Kelvin sensing (four-terminal sensing). Kelvin sensing employs separate current-carrying and voltage-sensing electrodes to provide more accurate electrical measurements. Accordingly, each electrical conductor 166a and 166b may include multiple electrically isolated electrodes, whether bundled together or sharing a common insulated casing.

The proximal ends of the electrical conductors 166a and 166b may be removably coupled with the battery booster 100 at the DC booster output 136a via one or more detachable electrical ports or connectors 164, such as EC5 connectors, barrel connectors, pin connectors, or magnetic connectors. In other examples, the proximal ends of the electrical conductors 166a and 166b may be fixedly coupled with the battery booster 100. One or both housings 102a and 102b may further include cable-management structures for wrapping, securing, or retracting cables.

FIG. 1b illustrates a block diagram of an example battery booster 100. The battery booster 100 may include one or more processors 128 configured to control operation of the battery booster 100, including monitoring and selectively charging or boosting external devices. The processor 128 may be operatively coupled to one or more memory devices, including a read-only memory (ROM) 118, a random-access memory (RAM) 120, and an internal data storage device 122. A clock 130 may provide timing signals to the processor 128. One or more bus structures may interconnect the components.

For purposes of illustration, the components are shown as being contained within a single housing 102. However, selected components or functionality may be distributed across multiple housings. Likewise, functionality illustrated as being performed by a single component may be distributed among multiple components. For example, multiple processors 128 may be employed and may communicate via serial communication.

The internal power supply 158 may be used to charge portable electronic devices 152, charge the external battery 104, jump-start an engine associated with the external battery 104, and/or power components of the battery booster 100. The internal power supply 158 may comprise one or more internal batteries 160 and/or one or more supercapacitors 162, which may be selectively charged or discharged using mechanical or solid-state switches. The internal power supply 158 may be rated to provide sufficient power for jump-starting a vehicle 106.

The internal battery 160 may comprise one or more rechargeable lithium battery cells arranged as a battery pack and configured to output direct current (DC) voltage. Example lithium battery chemistries include lithium iron phosphate, lithium polymer, lithium cobalt oxide, lithium titanate, lithium nickel manganese cobalt oxide, lithium iron magnesium phosphate, and lithium manganese oxide. The internal battery 160 may include a plurality of battery cells connected in series and/or parallel to achieve a desired nominal voltage.

The nominal voltage of the internal battery 160 may be selected as a function of the nominal voltage of the intended external battery 104. In certain aspects, the nominal voltages may be substantially matched. In other aspects, the nominal voltage of the internal battery 160 may exceed that of the external battery 104, for example by approximately 10% to 50%, more preferably 20% to 40%, to reduce current requirements during jump-starting and improve efficiency. The internal battery 160 may have a nominal voltage of approximately 6 V, 12 V, 16 V, 24 V, or 48 V.

A supercapacitor 162 may be used alone or in combination with the internal battery 160 to supply high peak power for jump-starting. The supercapacitor 162 may comprise a single supercapacitor or a plurality of supercapacitors electrically coupled in series and/or parallel. Supercapacitors are particularly suitable for jump-starting due to their ability to deliver large amounts of power over short durations.

To charge the internal power supply 158, the battery booster 100 may receive power via the DC input terminal 154 coupled to a DC power supply 156 and/or the AC input terminal 134 coupled to an AC power supply 148. In certain aspects, one of the DC output terminals 136 may function as both an input and an output terminal.

An AC-to-DC converter may be provided internally or externally. In certain aspects, the battery booster 100 may include a power inverter and an AC output terminal configured to supply AC power from the internal power supply 158.

When external power supplies are unavailable, the battery booster 100 may operate using power from the external battery 104 and/or the internal power supply 158. Status information may be communicated to portable electronic devices 152 via a communication network 170.

The battery booster 100 may further include an input/output interface 126 coupling the processor 128 to peripheral devices, including the user interface 138, a GPS transmitter 140, a wired link 142, a wireless communication device 144, a microphone 150, a speaker 124, and the display device 114 via a display driver 116.

The display device 114 may include light-emitting diodes (LEDs), an LCD screen, or a touch-enabled display. In certain aspects, multiple display devices 114 may be provided across different housings 102a and 102b to present redundant and/or function-specific information.

FIG. 1c illustrates a schematic diagram of an example battery booster 100 including a power management circuit 132 comprising a battery charge controller 178, a supercapacitor charge controller 180, a power output controller 182, and a single-ended primary-inductor converter (SEPIC) circuit 184. The SEPIC circuit 184 enables voltage step-up or step-down operation to accommodate varying input voltages and may be selectively bypassed to improve efficiency under certain conditions. The power management circuit 132 can, inter alia, charge and/or discharge the internal power supply 158 via the DC input terminal 154, the AC input terminal 134, or one of the DC output terminals 136 configured for bidirectional operation.

The power output controller 182 may include battery switches 190, supercapacitor switches 192, DC-to-DC converters 112, and a pulse-width modulation (PWM) driver 110. These components may be selectively controlled to provide bidirectional power flow between the internal power supply 158 and the DC output terminals 136.

The battery booster 100 may further provide reverse-polarity protection, automatic nominal voltage detection, preheating, solar charging capability, and automatic shut-off features. Jump-start functionality may be initiated locally or remotely, and the display device 114 may provide readiness, warning, and cooldown indications.

FIG. 1d illustrates a communication network 170 for use with the battery booster 100. The battery booster 100 may communicate with a remote interface device 172 directly or via the communication network 170. Through such communication, a user may monitor status, control operation, receive updates, and access historical data associated with the battery booster 100.

The power management circuit 132, via the battery charge controller 178, is configured to control charging and, when appropriate, discharging of the one or more internal batteries 160. In many multi-cell battery systems, charging and discharging control is commonly implemented using two transistor devices connected in series. In such arrangements, a body diode (e.g., an intrinsic diode of a field-effect transistor) may be positioned in parallel with one or more of the transistor devices. Under normal operating conditions, both transistors are turned on and conduct current. In an over-discharge or over-charge condition, the circuit may open one transistor while the associated diode blocks current flow in the opposite direction.

Because the transistors and associated diodes are connected in series in such conventional arrangements, the designer is typically required to select components capable of handling the full current rating for both the transistor and the diode. This requirement can result in one or more components being oversized relative to their typical operating requirements, leading to inefficiencies. By contrast, connecting transistors in parallel with externally provided diodes allows the diode and the transistor (e.g., a field-effect transistor (FET)) to be sized independently and more appropriately for their respective functions. This approach enables individual selection of diodes and transistors, or other switching components, based on desired electrical performance. In other examples, as discussed below, one of the transistors may be omitted or replaced, for example, with an electromechanical relay.

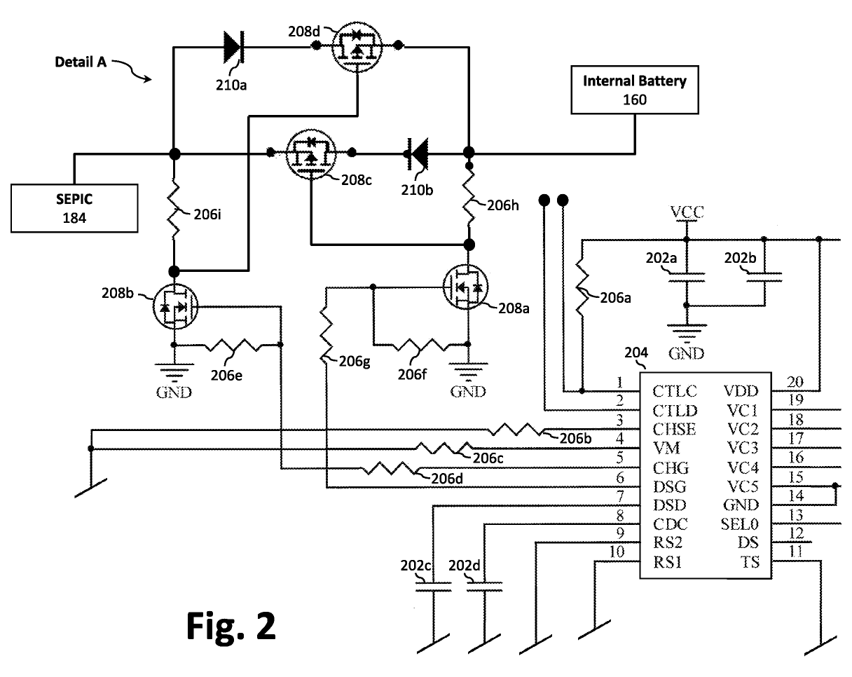

FIGS. 2 through 5 illustrate example overcharge and/or over-discharge protection subcircuits suitable for use with the internal battery 160, including multi-cell lithium batteries used therein, and which may be incorporated into the power management circuit 132 discussed herein. Elements that are common across the Figures retain the same reference numerals and perform the same or substantially the same functions unless otherwise stated.

FIG. 2 illustrates a partial schematic of a charge and discharge control circuit for an internal rechargeable battery 160 suitable for use with a multi-cell lithium-ion or lithium-polymer battery pack. The illustrated example employs a battery protection and management integrated circuit (“IC”) chip, identified as IC Chip 204, in combination with transistors 208 (e.g., MOSFETs), resistors 206, capacitors 220, and diodes 210 to selectively control charging and discharging of the rechargeable battery 160 using power provided by a SEPIC converter 184 or another charge power source.

In the illustrated example, IC Chip 204 is a protection integrated circuit configured for four-series or five-series lithium battery packs. In one non-limiting example, IC Chip 204 may be a SH367005 battery management IC. The IC Chip 204 is configured to monitor, with respect to the rechargeable battery 160, individual battery cell voltages, battery current conditions, and battery temperature, and to generate control signals for external charge and discharge switching devices based on the monitored conditions.

IC Chip 204 includes a plurality of control, detection, and sensing pins that cooperate to supervise battery charge, discharge, and operation. A charge control output is provided at a CTLC pin, and a discharge control output is provided at a CTLD pin. A charger detection input is provided at a CHSE pin to detect the presence of an external charging source, while a VM pin is used to detect load or discharge conditions.

A charge (CHG) pin (pin 5) is configured to output a signal to drive one or more external charge transistors (here, transistor 208b, which in turn drives transistor 208d), and a discharge (DSG) pin (pin 6) is configured to output a signal to drive one or more discharge transistors (here, first transistor 208a, which in turn drives third transistor 208c). A TS pin receives a temperature sensing signal associated with the battery pack. A SEL0 pin is provided to configure the IC for four-series or five-series battery operation by coupling the pin to either a supply voltage or a ground reference. A GND pin provides a ground reference for the IC, and a VDD pin supplies operating power. A plurality of voltage sensing inputs VC1–VC5 are coupled to individual battery cell nodes to monitor cell voltages.

Decoupling and stabilization of the supply voltage provided to IC Chip 204 can be accomplished using capacitors 220a and 220b, which may each be approximately 10 microfarads, 25-volt capacitors coupled between VDD and GND. Additional local bypassing and noise suppression are provided by capacitor 220c, having a capacitance of approximately 1 microfarad, and capacitor 220d, having a capacitance of approximately 100 nanofarads, which are coupled to appropriate supply or signal nodes of IC Chip 204 to promote stable operation.

The charge power source in the illustrated example is the SEPIC converter 184, which provides a regulated charging voltage suitable for charging the internal battery 160. The output of the SEPIC converter 184 is selectively coupled to the internal battery 160 through a controlled transistor and diode arrangement identified as Detail A. Together, transistors 208a–208d allow IC Chip 204 to independently control charging and discharging of the internal battery 160 based on detected operating conditions, including over-voltage, under-voltage, over-current, temperature-related fault conditions, and the presence or absence of a charging source.

The portion of the circuit identified as Detail A includes transistors 208a, 208b, 208c, and 208d, which collectively form the primary switching elements used to enable or disable charging and discharging of the internal battery 160 under the control of IC Chip 204. In the illustrated example, these transistors may be implemented as N-channel transistor devices, such as 2N7002 devices in SOT-23 packages, although other suitable switching devices may be employed. As illustrated, charge and discharge functions are facilitated primarily, in connection with IC Chip 204, using first, second, third, and fourth transistors 208a, 208b, 208c, and 208d; first and second diodes 210a and 210b; and various resistors (e.g., resistors 206e, 206f, 206g, 206h, and 206i). First diode 210a is coupled in series between the SEPIC converter 184 and a charge control node to provide unidirectional current flow and reverse-current protection. Second diode 210b is positioned in a discharge or system power path to prevent undesired current flow from the battery toward upstream circuitry.

With reference to FIG. 2 at Detail B, the first transistor 208a is connected between a gate of the third transistor 208c and ground, while the second transistor 208b is connected between a gate of the fourth transistor 208d and ground. The first and second transistors 208a and 208b control the switching of the third and fourth transistors 208c and 208d based on inputs from IC Chip 204 (e.g., the CHG and DSG signals at pins 5 and 6).

First transistor 208a is coupled between a control node associated with the discharge path and ground and is configured to be driven by a control signal (e.g., the DSG signal) derived from IC Chip 204. During operation, first transistor 208a functions as part of a discharge enable or inhibit path, permitting battery current to flow to a system load when enabled.

Second transistor 208b is positioned in the charge control path and is driven by the CHG output of IC Chip 204, either directly or through associated biasing resistors. Second transistor 208b is coupled to ground and associated with one or more resistors (e.g., resistor 206d) and is configured to provide controlled biasing or level shifting of gate drive signals, enabling proper operation of the charge and discharge transistors under varying battery and system voltage conditions. When the second transistor 208b is enabled, it allows the fourth transistor 208d to turn on, thereby permitting charging current from the SEPIC converter 184 to flow toward the internal battery 160.

Third transistor 208c is coupled in series with the second diode 210b in the discharge path, while the fourth transistor 208d is coupled in series with the first diode 210a in the charge path. Fourth transistor 208d operates as a controlled switching device that isolates the battery from the charging source when charging is disabled.

The combination of the third transistor 208c and the second diode 210b forms a controlled discharge path, while the combination of the fourth transistor 208d and the first diode 210a forms a controlled charge path. The first diode 210a is configured to prevent back-feeding and unwanted discharge toward the SEPIC converter 184, while the second diode 210b is configured to prevent reverse current flow from the system load toward the battery under undesired conditions.

By way of example, when charging is desired and permitted, the CHG signal from pin 5 of IC Chip 204 switches the second transistor 208b, which in turn allows the fourth transistor 208d to conduct, thereby enabling power from the SEPIC converter 184 to charge the internal battery 160 through diode 210a. Conversely, when discharging is desired and permitted, the DSG signal from pin 6 of IC Chip 204 switches the first transistor 208a, which in turn allows the third transistor 208c to conduct, thereby enabling the internal battery 160 to discharge through diode 210b to a system load.

The circuit further includes a resistor network that provides biasing, voltage sensing, pull-up and pull-down functions, current limiting, and timing or filtering characteristics. Resistors 206a and 206c, each having a resistance of approximately 1 kilo-ohm, are coupled in series with control or detection nodes to limit current and protect IC inputs or transistor gate terminals.

Resistors 206b, 206e, and 206f, each having a resistance of approximately 3 mega-ohms, form high-impedance bias networks that may be used for gate biasing, voltage division, or detection of charger or load presence while minimizing quiescent current. Resistors 206d, 206g, and 206h, each having a resistance of approximately 100 kilo-ohms, provide defined pull-up or pull-down paths for control signals such as CTLC, CTLD, CHSE, or VM. Resistor 206i, having a resistance of approximately 470 kilo-ohms, is coupled to a sensing or control node and may cooperate with capacitors or internal timing circuitry of IC Chip 204 to define delay or filtering characteristics.

Temperature monitoring is provided through the TS input of IC Chip 204, which is coupled to a temperature sensing network associated with the battery pack to allow charging or discharging to be inhibited when battery temperature is outside predefined safe limits. Individual cell voltages are monitored through the VC1–VC5 inputs, enabling detection of over-voltage, under-voltage, and cell imbalance conditions.

In operation, IC Chip 204 continuously monitors battery voltage, current, and temperature. When a valid charging source is detected at the CHSE input and operating conditions are within allowable limits, IC Chip 204 asserts a charge control signal that causes the CHG output to drive transistors 208b and 208d, thereby allowing current from the SEPIC converter 184 to charge the internal battery 160 through diode 210a. Conversely, when a load is detected at the VM input and discharge is permitted, IC Chip 204 asserts a discharge control signal that causes the DSG output to drive transistors 208a and 208c, allowing battery current to flow to the system load through diode 210b.

If any fault condition is detected, including over-charge, over-discharge, over-current, or over-temperature conditions, IC Chip 204 adjusts (e.g., terminates) the appropriate control signals, thereby turning off the associated transistors and electrically isolating the internal battery 160 from the charging source or the load. This action protects the battery pack and the host system from damage.

In the illustrated example, transistors 208a, 208b, 208c, and 208d operate as controllable switching elements under the direction of IC Chip 204 to selectively permit or inhibit current flow during charging and discharging of the internal battery 160. The specific component values, device types, and circuit topology illustrated in FIG. 2 are exemplary, and in other examples equivalent switching devices, passive component values, or power conversion sources may be employed without departing from the scope of the disclosed subject matter, provided that controlled charge and discharge of the battery is maintained under the supervision of a battery management integrated circuit.

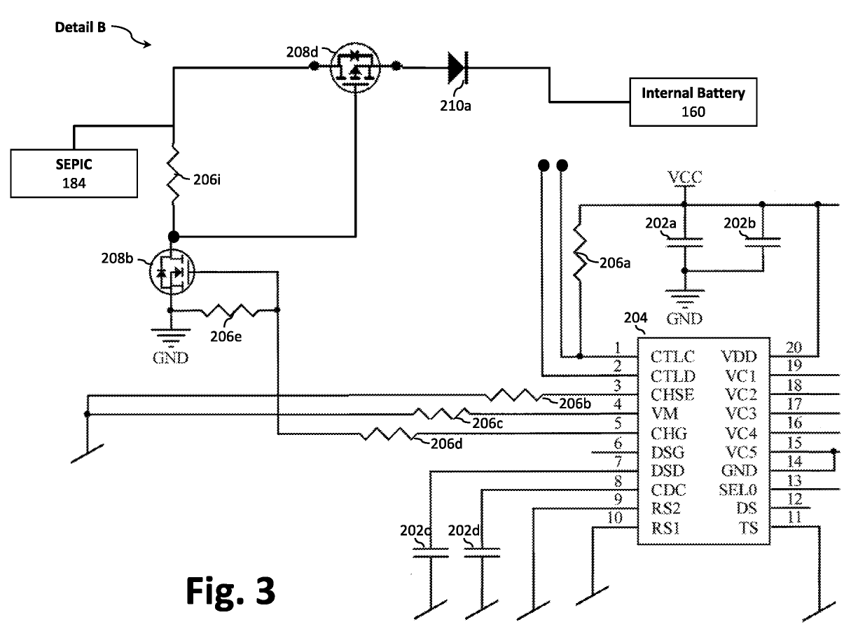

FIG. 3 illustrates an alternate example of the charge and discharge control circuitry previously described with respect to FIG. 2. Specifically, FIG. 3 provides an electrical schematic of an overcharge protection subcircuit (corresponding generally to Detail B of FIG. 2) that includes transistor 208d and diode 210a configured for charging the internal battery 160.

In this example, the overall function of controlling charging and discharging of the internal battery 160 using IC Chip 204 remains substantially the same; however, the configuration of the charging current path and associated switching elements is modified, particularly in the region associated with the charge control path.

As shown in FIG. 3, charging power from the SEPIC converter 184 is coupled to the internal battery 160 through an arrangement including transistor 208d and diode 210a. In contrast to the example of FIG. 2, the charging current path in FIG. 3 includes transistor 208d positioned more directly in series between the SEPIC converter 184 and the internal battery 160. Transistor 208d operates as a controlled switching device that selectively permits charging current to flow toward the battery under the control of IC Chip 204. Diode 210a remains coupled between the controlled switching node and the internal battery 160 to enforce unidirectional current flow and to inhibit reverse current from the battery toward the SEPIC converter 184.

Similar to the configuration described with respect to FIG. 2, transistor 208b is coupled to ground and operates as a gate control or pull-down device. Transistor 208b is driven in response to control signals derived from IC Chip 204 through the associated resistor network, including resistors 206e and 206c. When transistor 208b is turned on, the gate of transistor 208d is pulled toward ground, thereby turning off transistor 208d and interrupting the charging current path. Conversely, when IC Chip 204 authorizes charging operation, transistor 208b is turned off, allowing the gate of transistor 208d to be biased through resistor 206i to a voltage sufficient to place transistor 208d into conduction. In this state, charging current from the SEPIC converter 184 flows through transistor 208d and diode 210a into the internal battery 160. This indirect gate control arrangement provides an alternate mechanism for enabling and disabling battery charging while maintaining isolation between the charging source and the battery when charging is inhibited. Monitoring of individual cell voltages via VC1–VC5, temperature via the TS pin, and configuration via the SEL0 pin remains unchanged, and IC Chip 204 continues to disable charging or discharging upon detection of fault conditions.

Accordingly, the example of FIG. 3 provides an alternate implementation of the charging control path in which the charging transistor is biased and controlled through an intermediate transistor and resistor network. This configuration may provide advantages in gate drive flexibility, leakage control, or compatibility with different charging source characteristics, while preserving the overall protective and supervisory functions of IC Chip 204.

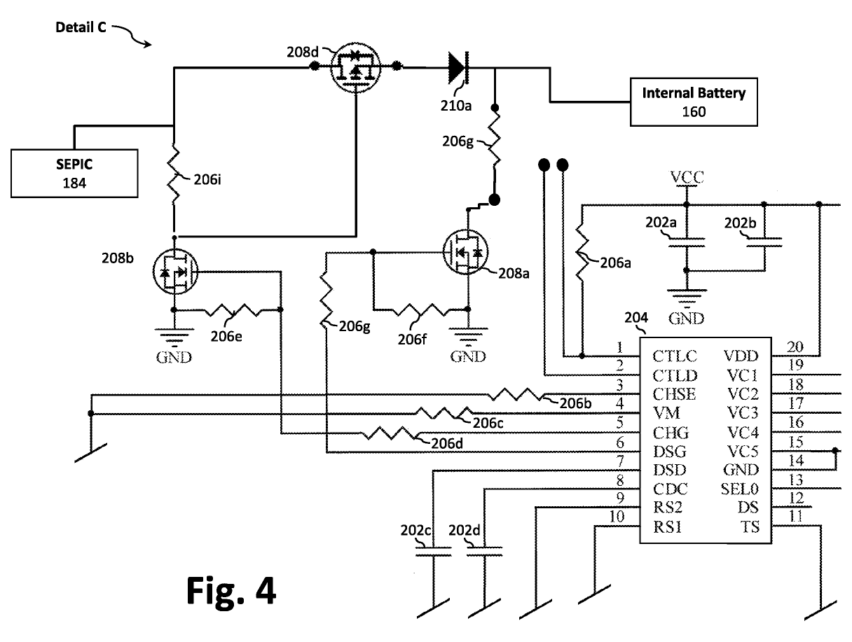

FIG. 4 illustrates an electrical schematic of an overcharge and over-discharge protection subcircuit (identified as Detail C), in which transistor 208d (together with transistor 208b) and diode 210a are used for charging the internal battery 160, while transistor 208c and associated gate control elements are used to control discharge of the internal battery 160.

As in the examples described with respect to FIGS. 2 and 3, IC Chip 204 operates as a battery protection and management controller that monitors cell voltages, temperature, and current-related conditions and selectively controls external switching devices to regulate charging and discharging of the battery. The example of FIG. 4 differs primarily in the configuration of the gate control circuitry associated with the charging and discharging transistors in the region identified as Detail C.

In the example shown in FIG. 4, charging power from the SEPIC converter 184 is coupled to the internal battery 160 through transistor 208d and diode 210a, which together form a controlled charging current path. Transistor 208d operates as a primary charge switching device, selectively enabling or disabling current flow from the SEPIC converter 184 to the battery under the supervisory control of IC Chip 204. Diode 210a remains coupled between the controlled switching node and the battery to prevent reverse current flow from the battery toward the charging source.

Unlike the example of FIG. 3, a gate bias network is used that includes transistor 208a and resistor 206g. In this arrangement, transistor 208a is coupled to ground and operates as an active gate control element that selectively clamps or releases the gate of transistor 208d in response to control signals originating from IC Chip 204. Resistor 206g provides controlled biasing between the gate of transistor 208d and a node associated with the battery or charging path, thereby establishing a defined gate voltage when transistor 208a is in a non-conductive state.

Transistor 208b continues to operate as a secondary control or biasing device coupled to ground, with its gate driven through resistor 206e. Together, transistors 208a and 208b form a coordinated gate control network that allows IC Chip 204 to more precisely regulate the turn-on and turn-off characteristics of transistor 208d. This configuration enables controlled charging behavior while reducing unintended leakage currents and improving isolation between the charging source and the battery when charging is disabled.

Discharge control in the example of FIG. 4 remains generally similar to that described with respect to FIG. 2. IC Chip 204 detects load conditions via the VM pin and, when discharge is permitted, asserts the DSG output to enable controlled current flow from the internal battery 160 to the system load through the designated discharge switching path. Monitoring of individual cell voltages via VC1–VC5, temperature via the TS pin, and configuration via the SEL0 pin remains unchanged, and IC Chip 204 disables charging or discharging upon detection of fault conditions.

The example illustrated in FIG. 4 provides an alternate charge and discharge gate control arrangement in which multiple external transistors cooperate to regulate the gate of the primary charging transistor. The configuration shown in the region of Detail C offers additional flexibility in gate biasing and control and may be advantageous in applications requiring enhanced isolation, reduced leakage, or improved robustness across varying operating conditions, while preserving the overall protective functionality provided by IC Chip 204.

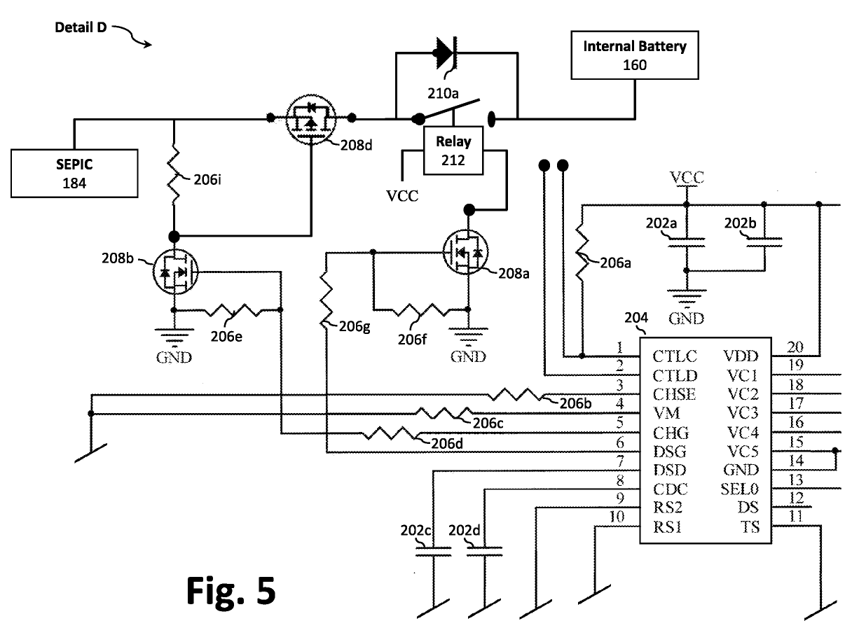

FIG. 5 illustrates an electrical schematic of an overcharge and over-discharge protection subcircuit (identified as Detail D) that includes transistor 208d and diode 210a, wherein a relay 212 is connected in parallel with diode 210b in the discharge path. The example of FIG. 5 is substantially similar in structure and operation to the example described with respect to FIG. 2, except that relay 212 is incorporated into the discharge current path in place of one of the transistor-based switching elements.

IC Chip 204 operates as a battery protection and management integrated circuit configured to monitor individual battery cell voltages, current conditions, and temperature, and to selectively control charging and discharging of the internal battery 160 through external switching devices. Charging of the internal battery 160 from a charging source, such as the SEPIC converter 184, is controlled using external transistors and diode 210a in a manner consistent with the previously described examples.

In the example illustrated in FIG. 5, the discharge current path from the internal battery 160 to the system load includes diode 210b and relay 212 connected in parallel with one another. Diode 210b provides a default unidirectional current path that limits reverse current flow and supports controlled, lower-current operation. Relay 212, when actuated, provides a low-resistance conductive path that bypasses diode 210b, thereby reducing voltage drop and power dissipation during high-current discharge conditions, such as a jump-starting operation.

Relay 212 is controlled indirectly by IC Chip 204 through transistor 208a. In this configuration, transistor 208a is coupled to the relay coil and is configured to selectively energize relay 212 in response to a discharge control signal generated by IC Chip 204. When IC Chip 204 determines that discharge is permitted and asserts the discharge control signal, transistor 208a is driven into conduction, thereby energizing relay 212 and closing the relay contacts. Closure of the relay contacts electrically couples the internal battery 160 to the system load through the low-resistance relay path, bypassing diode 210b.

When discharge is not permitted, or when a fault condition is detected, IC Chip 204 deasserts the discharge control signal, causing transistor 208a to turn off and de-energize relay 212. In this state, the relay contacts open, and discharge current is either blocked or limited to flow through diode 210b, depending on operating conditions. This arrangement allows IC Chip 204 to disconnect the internal battery 160 from the system load while maintaining reverse-current protection.

The use of relay 212 in parallel with diode 210b provides an alternate discharge control mechanism relative to the fully transistor-based implementation of FIG. 2. In particular, the relay-based bypass may be advantageous for handling high peak currents associated with jump-starting while reducing conduction losses and thermal stress on semiconductor switching devices. Aside from the inclusion and operation of relay 212 and its control via transistor 208a, the charging control, monitoring functions, and protective behavior of the circuit in FIG. 5 remain substantially similar as those described with respect to FIG. 2.

The above-cited patents and patent publications are hereby incorporated by reference in their entirety. Although various examples have been described with reference to a particular arrangement of parts, features, and the like, these are not intended to exhaust all possible arrangements or features, and indeed many other examples, modifications, and variations will be ascertainable to those of skill in the art. Thus, it is to be understood that the invention may therefore be practiced otherwise than as specifically described above.

What is claimed is:

1. A portable jump-starting device for supplying power to a vehicle having an external battery, the device comprising:
a pair of terminal connectors configured to be electrically coupled to the external battery of the vehicle;
an internal power source comprising a multi-cell lithium battery pack;
a power conversion circuit configured to provide a regulated charging voltage; and
a battery charge and discharge control circuit coupled between the internal power source and at least one of the terminal connectors and the power conversion circuit,
wherein the battery charge and discharge control circuit comprises:
a battery management integrated circuit configured to monitor voltage, current, and temperature conditions of the multi-cell lithium battery pack;
a charge current path including a first transistor and a first diode arranged in series between the power conversion circuit and the multi-cell lithium battery pack; and
a discharge current path including a second transistor and a second diode arranged in series between the multi-cell lithium battery pack and the terminal connectors, and
wherein the battery management integrated circuit is configured to independently control gate terminals of the first and second transistors to selectively enable and disable charging and discharging of the multi-cell lithium battery pack.

2. The device of claim 1, wherein the battery management integrated circuit is configured to monitor individual cell voltages of the multi-cell lithium battery pack through a plurality of cell sensing inputs.

3. The device of claim 1, wherein the battery management integrated circuit includes a charge control output and a discharge control output, the charge control output being coupled to a gate control network associated with the first transistor and the discharge control output being coupled to a gate control network associated with the second transistor.

4. The device of claim 1, wherein the battery charge and discharge control circuit further comprises a third transistor configured to selectively control a gate of the first transistor in response to a charge control signal from the battery management integrated circuit.

5. The device of claim 4, wherein the third transistor is configured to pull the gate of the first transistor toward a reference potential to disable charging.

6. The device of claim 1, wherein the battery charge and discharge control circuit further comprises a fourth transistor configured to selectively control a gate of the second transistor in response to a discharge control signal from the battery management integrated circuit.

7. The device of claim 1, wherein the first diode is configured to prevent reverse current flow from the multi-cell lithium battery pack toward the power conversion circuit.

8. The device of claim 1, wherein the second diode is configured to prevent reverse current flow from the terminal connectors toward the multi-cell lithium battery pack.

9. The device of claim 1, wherein the battery management integrated circuit is configured to disable at least one of the first and second transistors in response to detection of an over-voltage condition of at least one lithium battery cell.

10. The device of claim 1, wherein the battery management integrated circuit is configured to disable at least one of the first and second transistors in response to detection of an under-voltage condition of the multi-cell lithium battery pack.

11. The device of claim 1, wherein the battery management integrated circuit is configured to disable the second transistor in response to detection of an over-current condition during a jump-starting operation.

12. The device of claim 1, wherein the battery management integrated circuit is configured to disable at least one of the first and second transistors in response to detection of a temperature condition exceeding a predetermined threshold.

13. The device of claim 1, wherein the power conversion circuit comprises a single-ended primary-inductor converter (SEPIC) configured to provide the regulated charging voltage to the multi-cell lithium battery pack through the charge current path.

14. The device of claim 1, wherein the battery charge and discharge control circuit further comprises a resistor network coupled to control terminals of the first and second transistors and configured to provide gate biasing, pull-up, pull-down, and signal conditioning functions.

15. The device of claim 1, wherein charging and discharging of the multi-cell lithium battery pack are independently controlled through separate current paths.

16. The device of claim 1, wherein the first transistor is positioned directly in series between an output of the power conversion circuit and the multi-cell lithium battery pack.

17. The device of claim 16, wherein a gate of the first transistor is biased through a resistor to a conductive state when an associated gate control transistor is non-conductive.

18. The device of claim 1, wherein the battery charge and discharge control circuit further comprises a relay connected in parallel with the second diode in the discharge current path.

19. The device of claim 18, wherein the relay is configured to provide a low-resistance discharge path during a high-current jump-starting operation and is controlled by a transistor driven by the battery management integrated circuit.

20. The device of claim 1, wherein the battery charge and discharge control circuit electrically isolates the multi-cell lithium battery pack from both the power conversion circuit and the terminal connectors when charging and discharging are disabled.
